(19) United States
(12) Patent Application Publication
(10) Pub. No.: US 2013/0166632 A1
(43) Pub. Date: Jun. 27, 2013

(54) INFORMATION PROCESSING METHOD AND APPARATUS FOR ALLOTTING PROCESSING

(71) Applicant: Fujitsu Limited, Kawasaki-shi (JP)

(72) Inventors: Koichi YAMASAKI, Kawasaki (JP); Kazuki Matsui, Kawasaki (JP)

(73) Assignee: FUJITSU LIMITED, Kawasaki-shi (JP)

(21) Appl. No.: 13/671,154

(22) Filed: Nov. 7, 2012

(30) Foreign Application Priority Data
Dec. 26, 2011 (JP) 2011-282990

(51) Int. Cl. G06F 15/16

(52) U.S. Cl. 709/203

(57) ABSTRACT

The disclosed invention describes an information processing apparatus, including a first processor, and a second processor. The first processor execute a procedure, including: while the second processor executes an image processing, obtaining utilization ratios of the second processor at two or more timings; first determining, by using the obtained utilization ratios, whether or not a predetermined change occurred in the utilization ratios of the second processor; upon determining that the predetermined change occurred, second determining, based on obtained utilization ratios, which processes of a plurality of processes to be executed to display screen data on a client terminal should be allocated to the second processor; and performing a setting to execute the plurality of processes according to a determination result.

### CROSS-REFERENCE TO RELATED APPLICATIONS

This application is based upon and claims the benefit of priority of the prior Japanese Patent Application No. 2011-282990, filed on Dec. 26, 2011, the entire contents of which are incorporated herein by reference.

### FIELD

This technique relates to a technique for allotting a processing to plural processors.

### BACKGROUND

In view of reducing a cost for operating and managing a system and taking countermeasures for the leakage of information, an attention is paid to a thin client system. With such a situation, Desktop as a Service (DaaS) in which a user desktop environment is built in a server on a cloud and is provided through a network for the user is being provided. Such a service was frequently used for creating documents, viewing e-mail, browsing web sites and the like. However, in recent years, such a service is also used for watching movies, using Computer Aided Design (CAD), and the like.

Following two methods are known for a method for communicating with a client terminal and a server in the aforementioned system. A first method is a method for transmitting drawing commands for the desktop screen in the server to the client terminal by using a protocol such as Remote Desktop Protocol (RDP), and executing the drawing commands on the client terminal to render the screen. A second method is a method for transmitting contents of the desktop screen in the server as image data by using a protocol such as Remote FrameBuffer (RFB) to display the image data on the screen of the client terminal.

However, in case of watching the movies or using CAD, when a former method is used, the number of drawing commands easily increases, and the delay of the response easily becomes large. Then, it is considered that a latter method is used so that an operator of the client terminal can watch the movies or use CAD in comfort.

Conventionally, a technique for reducing loads of a Central Processing Unit (CPU) by causing a Graphics Processing Unit (GPU) to execute parts of a processing to be executed by the CPU exists, which is known as General-Purpose computing on Graphics Processing Units (GPGPU). However, when simply applying this technique to the aforementioned system, it is impossible to appropriately limit the number of cores in the GPU, which is to be allocated to the processing for transmitting the image data. Therefore, the processing of application programs using the GPU such as CAD may be delayed, and the response to an operation on a user terminal may be delayed.

In addition, as for the image processing, a following technique also exists. Specifically, when a rendering event for a cell occurs, a processor for loading image data to a predetermined graphic memory identifies source data associated with the cell from a predetermined basic recording space. Moreover, the processor sequentially loads unit source data included in the identified source data onto the graphic memory predetermined intervals. On the other hand, a video processor generates an image by rendering the unit source data that was loaded onto the graphic memory, and displays the image on a display unit. However, this technique does not pay attention to improving the response in the aforementioned system.

In other words, conventional arts cannot display results of the image processing executed in the server on the client terminal smoothly.

### SUMMARY

An information processing method relating to an aspect of this technique is executed by a first processor included in a computer further including a second processor. Then, the information processing method includes: (A) while the second processor executes an image processing, obtaining utilization ratios of the second processor at two or more timings; (B) first determining, by using the obtained utilization ratios, whether or not a predetermined change occurred in the utilization ratios of the second processor; (C) upon determining that the predetermined change occurred, second determining, based on obtained utilization ratios, which processes of a plurality of processes to be executed to display screen data on a client terminal should be allocated to the second processor; and (D) performing a setting to execute the plurality of processes according to a determination result.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting a system outline in a first embodiment;

FIG. 2 is a functional block diagram of a server;

FIG. 3 is a diagram depicting modes of processing allotment of GPU and CPU in each operation mode;

FIG. 4 is a diagram depicting an example of data stored in an operation mode storage unit;

FIG. 5 is a diagram depicting an example of data stored in a determined data storage unit;

FIG. 6 is a diagram depicting a processing flow of a processing executed in the server;

FIG. 7 is a diagram depicting the processing flow of the processing executed in the server;

FIG. 8 is a diagram depicting an example of data stored in a pattern storage unit;

FIG. 9 is a diagram depicting a processing flow of an operation mode determination processing;

FIG. 10 is a diagram depicting a processing flow of the processing executed in the server;

FIG. 11 is a diagram depicting a processing flow of a processing executed by an activation monitor;

FIG. 12 is a diagram depicting a processing flow of a processing executed by an API monitor;

FIG. 13 is a diagram depicting a processing flow of a processing executed by an acquisition unit;

FIG. 14 is a diagram depicting a processing flow of a processing executed by a determining unit;

FIG. 15 is a diagram depicting the processing flow of the processing executed by the determining unit;

FIG. 16 is a diagram depicting the processing flow of the processing executed by the determining unit;

FIG. 17 is a diagram depicting the processing flow of the processing executed by the determining unit;

FIG. 18 is a diagram depicting the processing flow of the processing executed by the determining unit;

FIG. 19 is a diagram depicting a processing flow of a processing executed by a notification unit;

FIG. 20 is a diagram depicting a processing flow of a processing executed by a comparator;

FIG. 21 is a diagram depicting a processing flow of a processing executed by a change unit;

FIG. 22 is a diagram depicting a processing flow of a processing executed by a measurement unit;

FIG. 23A is a diagram depicting an example of data stored in the determined data storage unit in a second embodiment;

FIG. 23B is a diagram depicting a processing flow of an operation mode determination processing in the second embodiment;

FIG. 24 is a diagram depicting a setting example of a threshold for each drawing commands in a third embodiment;

FIG. 25 is a diagram depicting a processing flow of a processing executed by the notification unit in a fifth embodiment;

FIG. 26 is a diagram depicting a processing flow of a processing executed by the determining unit in the fifth embodiment;

FIG. 27 is a diagram depicting the processing flow of the processing executed by the determining unit in a sixth embodiment;

FIG. 28 is a diagram depicting an example of data stored in a pattern storage unit in the sixth embodiment; and

FIG. 29 is a functional block diagram of a computer.

### DESCRIPTION OF EMBODIMENTS

### First Embodiment

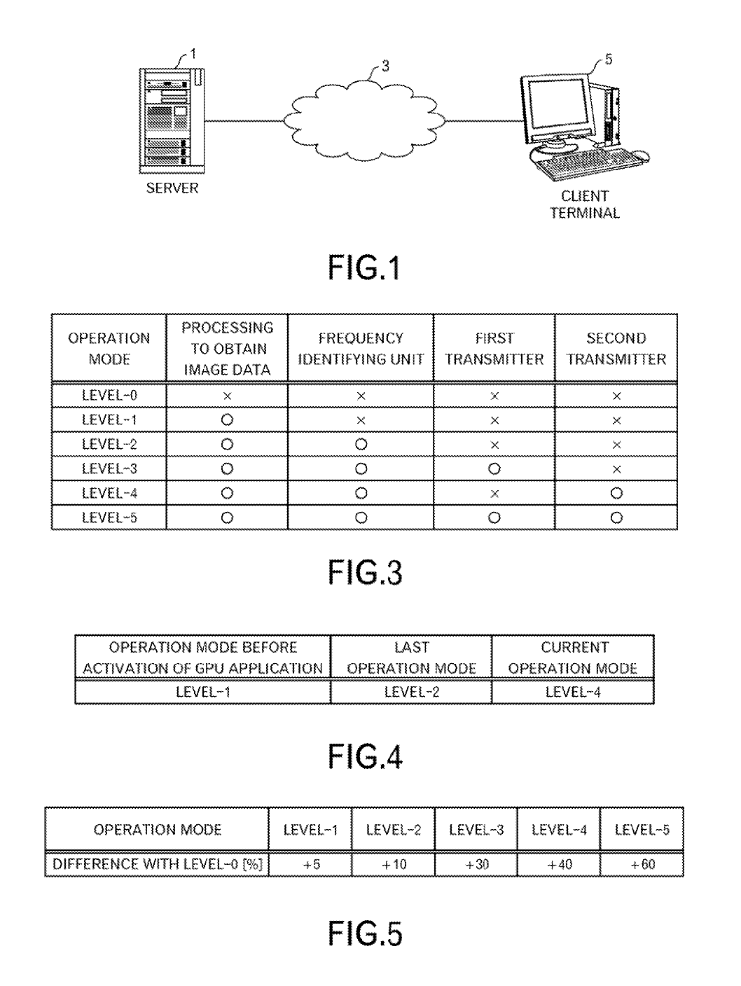

FIG. 1 illustrates a system outline in a first embodiment. A system illustrated in FIG. 1 is a system to provide DaaS, for example, and a server 1 is connected through a network 3 such as the Internet with a client terminal 5. The system illustrated in FIG. 1 is a thin client system, and because the client terminal 5 only has limited functions, a user of the client terminal 5 utilizes functions the server 1 has through the network 3.

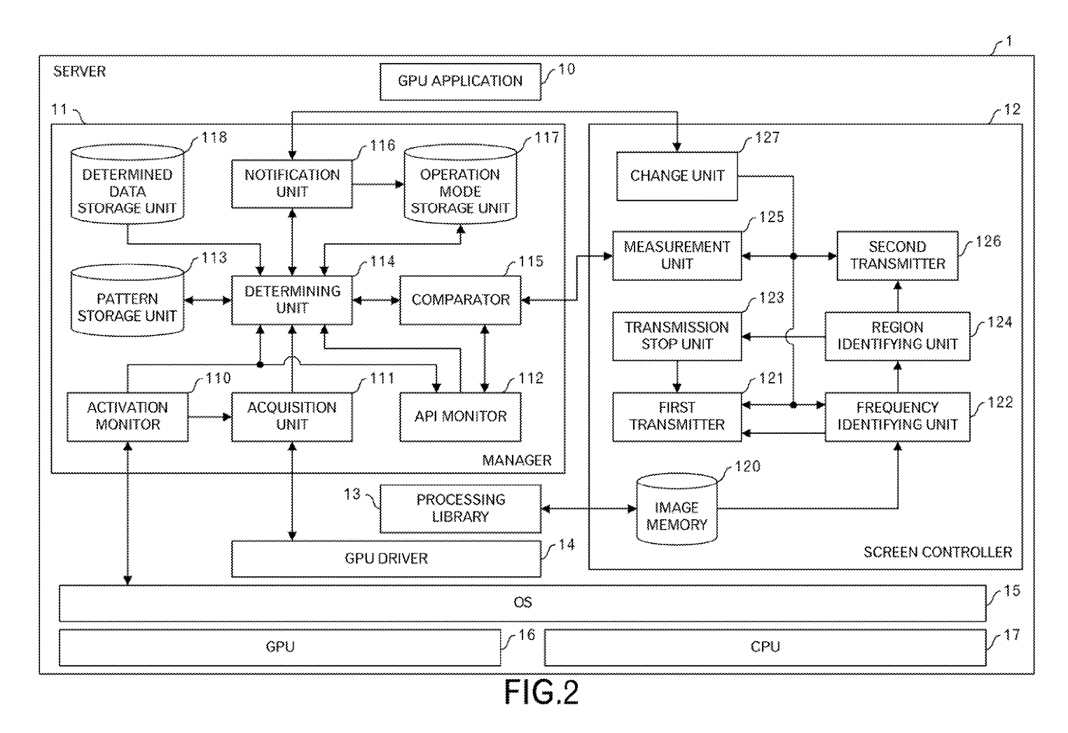

FIG. 2 illustrates a configuration of the server 1. The server 1 has a GPU application 10, manager 11, screen controller 12, processing library 13, GPU driver 14, Operating System (OS) 15, GPU 16, and CPU 17. Moreover, the manager 11 includes an activation monitor 110, acquisition unit 111, Application Programming Interface (API) monitor 112, pattern storage unit 113, determining unit 114, comparator 115, notification unit 116, operation mode storage unit 117 and determined data storage unit 118. Furthermore, the screen controller 12 includes an image memory 120, first transmitter 121, frequency identifying unit 122, transmission stop unit 123, region identifying unit 124, measurement unit 125, second transmitter 126 and change unit 127.

The GPU application 10 is an application program (e.g. CAD program) that utilizes the GPU 16. The GPU application 10 utilizes the GPU 16 through the processing library 13 and the GPU driver 14. The activation monitor 110 monitors through the OS 15 whether or not the GPU application 10 is activated, and when the GPU application 10 is activated, the activation monitor 110 transmits an operation start request to the acquisition unit 111, API monitor 112 and determining unit 114. The acquisition unit 111 obtains a utilization rate of the GPU 16 through the GPU driver 14. The API monitor 112 receives a drawing command outputted from the GPU application 10 to the GPU 16. The determining unit 114 performs a processing to determine an operation mode to be applied by using data stored in the pattern storage unit 113, operation mode storage unit 117 and determined data storage unit 118. The comparator 115 determines whether or not the delay occurs in a processing by the GPU application 10 or whether or not the frame rate is lowered, after change of the operation mode. The notification unit 116 transmits a change request including an identifier of the operation mode determined by the determining unit 114 to the change unit 127.

According to the operation mode notified from the notification unit 116, the change unit 127 performs a setting concerning which of the GPU 16 and CPU 17 performs a processing, for the first transmitter 121, frequency identifying unit 122 and second transmitter 126. Image data obtained through the processing library 13 and GPU driver 14 is stored in the image memory 120. The frequency identifying unit 122 divides a screen relating to the screen data stored in the image memory 120 into plural regions, identifies a frequency of changes between frames for each regions, and transmits data concerning the frequencies to the region identifying unit 124. The region identifying unit 124 notifies the second transmitter 126 of a region (i.e. a high frequency region) whose frequency of the changes exceeds a predetermined threshold. The second transmitter 126 is a processing unit that transmits data of a movie, and transmits the image data having a higher compression ratio than the first transmitter 121 in the high frequency region to the client terminal 5. The transmission stop unit 123 performs a setting for the first transmitter 121 so as to stop the transmission of the image data in the high frequency region. The first transmitter 121 is a processing unit that transmits data of a still image, and transmits the image data of a region having a change to the client terminal 5. The measurement unit 125 measures a frame rate (the unit is Frames Per Second (FPS)), and transmits the measurement results to the comparator 115. Furthermore, the image memory 120, first transmitter 121, frequency identifying unit 122, transmission stop unit 123, region identifying unit 124 and second transmitter 126 are described in detail in US 2011/0276653 A1, and they are not main portions in this embodiment. Therefore, detailed description for them will be omitted.

Furthermore, in this embodiment, the processing of the first transmitter 121, frequency identifying unit 122 and second transmitter 126 among the processing units illustrated in FIG. 2 can be executed by the GPU 16.

FIG. 3 illustrates a processing allotment of the GPU 16 and CPU 17 in each operation mode. The processing illustrated in FIG. 3 can be executed in parallel, and a circle mark represents the GPU 16 is in charge of the processing, and an X mark represents the CPU 17 is in charge of the processing. Thus, a combination of the processing of which the GPU 16 is in charge is predetermined for each operation mode. For example, in the level-2 operation mode, the GPU 16 is in charge of the processing to obtain the image data and the processing of the frequency identifying unit 122, and the CPU 17 is in charge of the processing of the first transmitter 121 and second transmitter 126. As illustrated in FIG. 3, the processing of which the GPU 16 is in charge increases, when the level of the operation mode is heightened.

FIG. 4 illustrates an example of data stored in the operation mode storage unit 117. In an example of FIG. 4, an identifier of the operation mode before the activation of the GPU application 10, an identifier of the last operation mode and an identifier of the current operation mode are stored.

FIG. 5 illustrates an example of data stored in the determined data storage unit 118. In an example of FIG. 5, for each of the operation modes of level-1 to level-5, a difference value in the GPU utilization ratio with a case where the operation mode of level-0 (i.e. the operation mode in which the processing in the screen controller 12 is not executed by the GPU 16) is applied is stored.

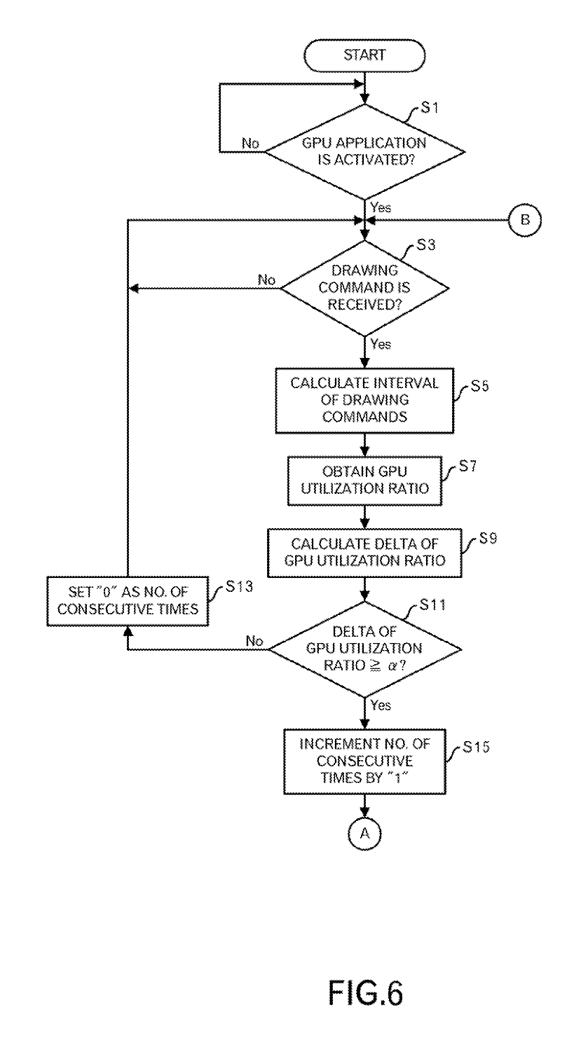

Next, the operation of the server 1 illustrated in FIG. 2 will be explained using FIGS. 6 to 22. Firstly, after explaining the overall flow of the processing performed by the server 1, the processing performed by the respective processing units will be explained in detail.

First, the activation monitor 110 monitors whether or not the GPU application 10 is activated (FIG. 6: step S1). When the GPU application 10 has not been activated (step S1: No route), the processing returns to the step S1.

When the GPU application 10 is activated (step S1: Yes route), the activation monitor 110 sends an operation start request to the acquisition unit 111, API monitor 112 and determining unit 114. Then, the API monitor 112 that received the operation start request determines whether or not a drawing command is received from the GPU application 10 (step S3). When the drawing command has not been received (step S3: No route), the processing returns to the step S3.

When the drawing command is received (step S3: Yes route), the API monitor 112 stores the drawing command and receipt time of the drawing command into a storage device such as a main memory. Then, the API monitor 112 calculates an interval of the drawing commands by using the receipt time of the drawing command that was received this time and the receipt time of the drawing command that was received before, and stores the interval into the storage device (step S5). At the step S5, an average value of the intervals is calculated by using the receipt time of the drawing command that was received this time and the receipt times of the several drawing commands that were received before.

On the other hand, the acquisition unit 111 that received the operation start request obtains the GPU utilization ratio through the GPU driver 14, and transmits the obtained GPU utilization ratio to the determining unit 114 (step S7). Incidentally, the acquisition unit 111 obtains the GPU utilization ratio, periodically.

The determining unit 114 calculates a delta of the GPU utilization ratio by calculating a difference between the GPU utilization ratio that was obtained previous time and the GPU utilization ratio that was obtained this time, and stores the delta into the storage unit (step S9). The determining unit 114 determines whether or not the delta of the GPU utilization ratio is equal to or greater than a threshold α (step S11). The threshold α is predetermined by the administrator of the server 1 or the like. When the delta of the GPU utilization ratio is not equal to or greater than the threshold α (step S11: No route), the operation mode is not changed. Therefore, the determining unit 114 sets “0” as a variable value representing the number of consecutive times (step S13), and the processing returns to the step S3.

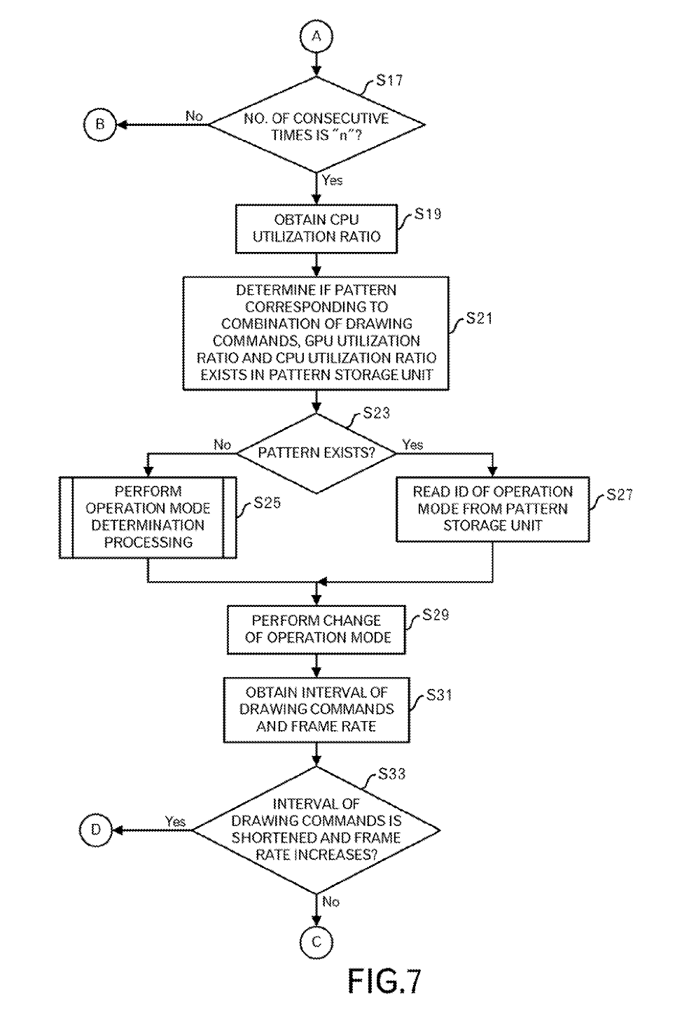

On the other hand, when the delta of the GPU utilization ratio is equal to or greater than the threshold α (step S11: Yes route), the determining unit 114 increments the variable value representing the number of consecutive times by “1” (step S15). The processing shifts to step S17 of FIG. 7 through a terminal A.

Shifting to the explanation of FIG. 7, the determining unit 114 determines whether or not the variable value representing the number of consecutive times is n (n is a natural number equal to or greater than “2”) (step S17). When the variable value representing the number of consecutive times does not reach n (step S17: No route), the processing returns to step S3 of FIG. 6 through a terminal B.

On the other hand, when the variable value representing the number of consecutive times reached the threshold n (step S17: Yes route), the determining unit 114 obtains the CPU utilization ratio, and stores the obtained CPU utilization ratio into the storage device (step S19). Moreover, the determining unit 114 determines whether or not a pattern corresponding to the combination of drawing commands, GPU utilization ratio and CPU utilization ratio is registered in the pattern storage unit 113 (step S21).

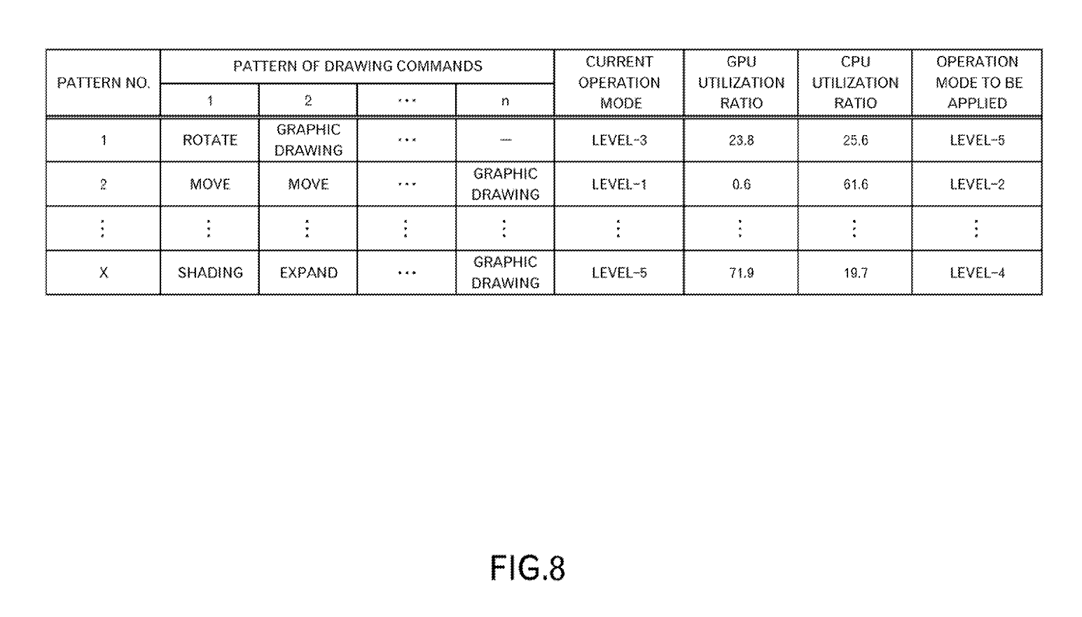

FIG. 8 illustrates an example of data stored in the pattern storage unit 113. In an example of FIG. 8, a pattern number, pattern (i.e. combination) of drawing commands, identifier of the current operation mode, GPU utilization ratio, CPU utilization ratio, and identifier of the operation mode to be applied are stored. At the step S21, it is determined whether or not a pattern in which the combination of the drawing commands is identical, the GPU utilization ratio is similar (e.g. the difference is within a predetermined range or the like) and the CPU utilization ratio is also similar is registered.

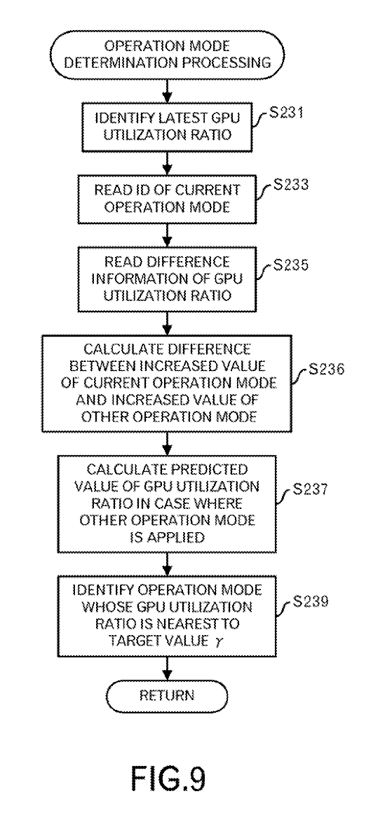

When there is a pattern corresponding to the combination of the drawing commands, the GPU utilization ratio and the CPU utilization ratio (step S23: Yes route), the determining unit 114 reads out an identifier of the operation mode to be applied for that pattern from the pattern storage unit 113 (step S27). On the other hand, when there is no pattern corresponding to the combination of the drawing commands, the GPU utilization ratio and the CPU utilization ratio (step S23: No route), the determining unit 114 performs an operation mode determination processing (step S25). The operation mode determination processing will be explained by using FIG. 9.

First, the determining unit 114 identifies the latest GPU utilization ratio among the GPU utilization ratios received from the acquisition unit 111 (FIG. 9: step S231). In addition, the determining unit 114 reads out the identifier of the current operation mode from the operation mode storage unit 117 (step S233).

The determining unit 114 reads out, for each operation mode, the difference value in the GPU utilization ratio with the case where the operation mode of the level-0 is applied (i.e. an increased value of the GPU utilization ratio) from the determined data storage unit 118 (step S235). Then, the determining unit 114 calculates a difference between the increased value corresponding to the current operation mode and the increased value corresponding to each of the other operation modes (step S236). For example, when the data illustrated in FIG. 5 is stored in the determined data storage unit 118 and the current operation mode is the level-3, the calculated value for the level-0 is “−30”, the calculated value for the level-1 is “−25”, the calculated value for the level-2 is “−20”, the calculated value for the level-3 is “0”, the calculated value for the level-4 is “+10”, and the calculated value for the level-5 is “+30”.

The determining unit 114 calculates a predicted value of the GPU utilization ratio in a case where each of the operation modes is applied, by calculating a sum of the difference value calculated at the step S236 and the GPU utilization ratio identified at the step S231 (step S237). For example, when the GPU utilization ratio identified at the step S231 is “60”, the predicted value for the level-0 is “30”, the predicted value for the level-1 is “35”, the predicted value for the level-2 is “40”, the predicted value for the level-3 is “60”, the predicted value for the level-4 is “70” and the predicted value for the level-5 is “90”.

The determining unit 114 identifies an identifier of the operation mode whose predicted value of the GPU utilization ratio is nearest to a predetermined target value of the GPU utilization ratio (step S239). For example, when the target value is “100”, “level-5” is identified as the identifier of the operation mode. Then, the processing returns to the calling-source processing.

By performing the aforementioned processing, it is possible to determine the operation mode nearest to the predetermined target value of the GPU utilization ratio.

Returning to the explanation of FIG. 7, when the identifier of the operation mode is identified at the step S25 or the identifier of the operation mode is read out at the step S27, the determining unit 114 transmits a change request including the identifier of the operation mode to the notification unit 116. Then, the notification unit 116 transmits a change request including the received identifier of the operation mode to the change unit 127.

Then, the change unit 127 performs a change of the operation mode (step S29). For example, when the operation mode is changed from the level-3 to the level-5, a setting for causing the GPU 16 to execute a processing for the first transmitter 121 and second transmitter 126 is conducted.

On the other hand, the comparator 115 obtains an interval of the drawing commands before the change of the operation mode and an interval of the drawing commands after the change of the operation mode from the API monitor 112, and obtains frame rates before and after the change of the operation mode from the measurement unit 125 (step S31).

The comparator 115 determines whether or not the interval of the drawing commands is shortened and the frame rate increases (step S33). More specifically, in case of the interval Xp of the drawing commands before the change of the operation mode, the interval Xq of the drawing commands after the change of the operation mode, the frame rate Yp before the change of the operation mode and the frame rate Yq after the change of the operation mode, it is determined whether or not Xq−Xp<0 and Yq−Yp>0 are satisfied. However, because any errors of the measurements may exist, it may be permissible that Xq−Xp is not less than “0” and/or Yq−Yp is not greater than “0”. In other words, by using a positive threshold β and a negative threshold y, it may be determined whether or not Xq−Xp<β and Yq−Yp>y are satisfied.

Incidentally, when the interval of the drawing commands becomes long, there is a possibility that the GPU 16 cannot cope with the processing requests from the GPU application 10 and screen controller 12. On the other hand, when the frame rate is lowered, there is a possibility that a sequential processing such as the screen capture, still image compression, movie encoding and screen data transmission to the client terminal 5 is delayed.

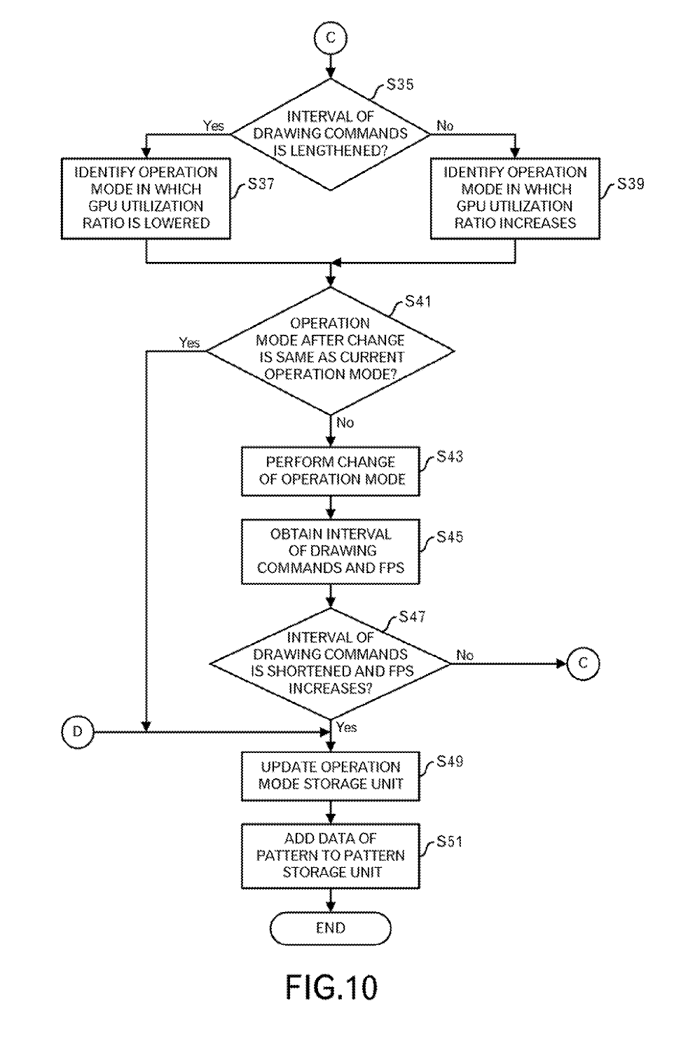

When the interval of the drawing commands is shortened and the frame rate increases (step S33: Yes route), the processing shifts to step S49 in FIG. 10 through a terminal D. On the other hand, when the interval of the drawing commands extends, or the frame rate is lowered (step S33: No route), the processing shifts to step S35 in FIG. 10 through a terminal C.

Shifting to the explanation of FIG. 10, the comparator 115 notifies the determining unit 114 of the result of the step S33. The determining unit 114 determines whether or not the result notified from the comparator 115 represents the interval of the drawing commands is lengthened (step S35). When the interval of the drawing commands is lengthened (step S35: Yes route), the determining unit 114 identifies an identifier of the operation mode in which the GPU utilization ratio is lowered than the current operation mode (step S37). This is because the delay of the processing of the GPU application 10 may be caused by changing the operation mode. For example, when the identifier of the current operation mode is “level-3”, “level-0”, “level-1” or “level-2” is identified.

On the other hand, when the interval of the drawing commands is shortened (step S35: No route), the processing speed of the GPU application 10 increases, however, the frame rate is lowered. Therefore, the determining unit 114 identifies an identifier of the operation mode in which the GPU utilization ratio is heightened than the current operation mode (step S39). Because the GPU 16 has a surplus processing capability, parts of the processing of the screen controller 12 is allocated to the GPU 16 to decrease the load of the CPU 17. For example, when the identifier of the current operation mode is “level-3”, “level-4” or “level-5” is identified.

The determining unit 114 determines whether or not the operation mode after the change is the same as the current operation mode (step S41). When it is determined that the operation mode after the change is the same as the current operation mode (step S41: Yes route), the processing shifts to a processing of step S49.

On the other hand, when the operation mode after the change is not the same as the current operation mode (step S41: No route), the determining unit 114 transmits a change request including the identifier of the operation mode after the change to the notification unit 116. Then, the notification unit 116 transmits a change request including the received identifier of the operation mode to the change unit 127. After that, the change unit 127 changes the operation mode (step S43). This processing is the same as the processing of the step S29.

On the other hand, the comparator 115 obtains the interval of the drawing commands before the change of the operation mode and the interval of the drawing commands after the change of the operation mode from the API monitor 112, and obtains the frame rates before and after the change of the operation mode from the measurement unit 125 (step S45).

The comparator 115 determines whether or not the interval of the drawing commands is shortened and the frame rate increases (step S47).

When the interval of the drawing commands is lengthened or the frame rate is lowered (step S47: No route), the processing returns to the step S35 through the terminal C.

On the other hand, when the interval of the drawing commands is shortened and the frame rate increases (step S47: Yes route), the determining unit 114 updates data stored in the operation mode storage unit 117 (step S49). Specifically, data in the column of the operation mode before the change is updated with the identifier of the operation mode stored in the column of the current operation mode in the operation mode storage unit 117. Moreover, data in the column of the current operation mode is updated with the identifier of the operation mode, which is identified at the step S37 or S39.

Then, the determining unit 114 adds data of the pattern in the pattern storage unit 113 (step S51). Specifically, first, a new pattern number is assigned. In addition, the identifier of the current operation mode is stored in the column of the operation mode to be applied, and the identifier of the operation mode before the change is stored in the column of the operation mode before the change. Furthermore, the obtained data is stored in each column of the combination of the drawing commands, GPU utilization ratio and CPU utilization ratio. However, when a similar pattern has already been stored in the pattern storage unit 113 (e.g. when the processing of the step S27 has been carried out or the like), the processing of the step S51 may not be performed.

By performing the aforementioned processing, it is possible to suppress the influence to the image processing by the GPU application 10 and utilize the GPU 16 for the processing of the screen controller 12. Thus, the response to the operation in the client terminal 5 is improved.

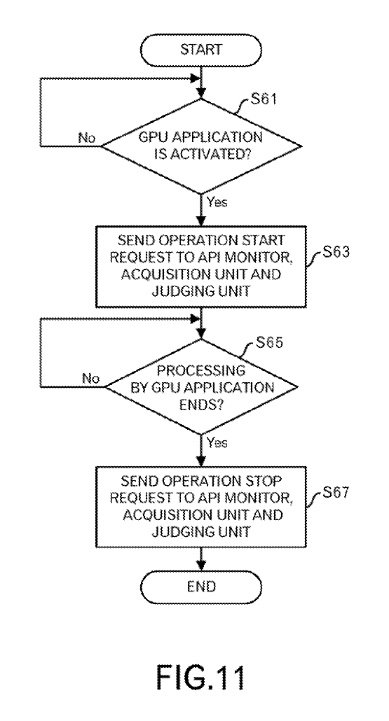

Next, the processing by each processing unit will be explained. First, the processing of the activation monitor 110 will be explained by using FIG. 11.

Firstly, the activation monitor 110 determines whether or not the GPU application 10 is activated (FIG. 11: step S61). When the GPU application 10 has not been activated (step S61: No route), the processing returns to the step S61.

On the other hand, when the GPU application 10 is activated (step S61: Yes route), the activation monitor 110 transmits an operation start request to the API monitor 112, acquisition unit 111 and determining unit 114 (step S63).

The activation monitor 110 determines whether or not the processing by the GPU application 10 is completed (step S65). When the processing by the GPU application 10 is not completed (step S65: No route), the processing returns to the step S65.

On the other hand, when it is determined that the processing by the GPU application 10 is completed (step S65: Yes route), the activation monitor 110 transmits an operation stop request to the API monitor 112, acquisition unit 11 and determining unit 114 (step S67). Then, the processing ends.

By performing such a processing, it is possible to start the processing in this embodiment when the GPU application 10 is activated.

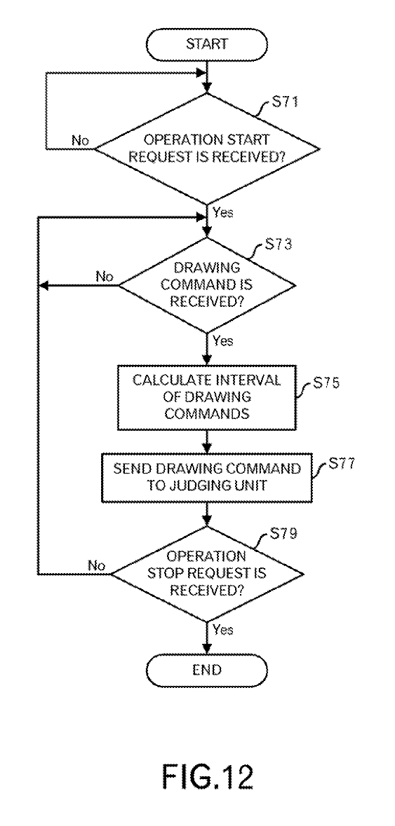

Next, a processing of the API monitor 112 will be explained by using FIG. 12. First, the API monitor 112 determines whether or not an operation start request is received from the activation monitor 110 (FIG. 12: step S71). When the operation start request has not been received (step S71: No route), the processing returns to the step S71.

On the other hand, when the operation start request is received (step S71: Yes route), the API monitor 112 determines whether or not a drawing command is received from the GPU application 10 (step S73). When the drawing command has not been received (step S73: No route), the processing returns to the step S73.

On the other hand, when the drawing command is received (step S73: Yes route), the API monitor 112 stores received drawing command and receipt time of the drawing command into a storage unit. Then, the API monitor 112 calculates an interval of the drawing commands by using the receipt time of the drawing command that was received this time and the receipt times of the drawing commands that were received before, and stores the calculated interval into the storage unit (step S75). At the step S75, the receipt time of the drawing command that was received this time and the predetermined number of receipt times of the drawing commands that were received before are used to calculate an average interval.

The API monitor 112 transmits the received drawing command to the determining unit 114 (step S77). Then, the API monitor 112 determines whether or not an operation stop request is received from the activation monitor 110 (step S79). When the operation stop request has not been received (step S79: No route), the processing returns to the step S73. On the other hand, when the operation stop request is received (step S79: Yes route), the processing ends.

By performing the aforementioned processing, it becomes possible to confirm whether or not the image processing by the GPU application 10 is delayed.

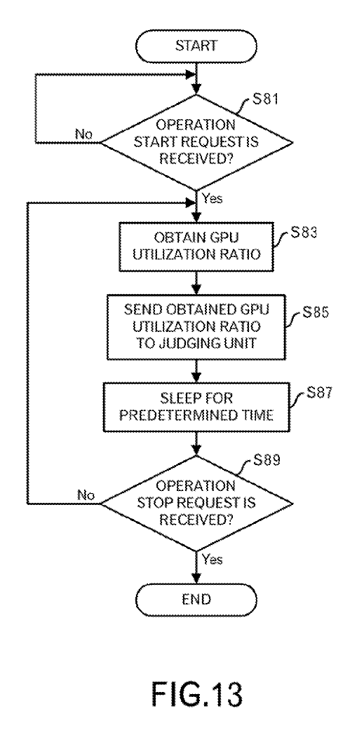

Next, a processing of the acquisition unit 111 will be explained by using FIG. 13. First, the acquisition unit 111 determines whether or not the operation start request is received from the activation monitor 110 (FIG. 13: step S81). When it is determined that the operation start request has not been received (step S81: No route), the processing returns to the step S81.

On the other hand, when the operation start request is received (step S81: Yes route), the acquisition unit 111 obtains the GPU utilization ratio through the GPU driver 14 (step S83), and transmits the obtained GPU utilization ratio to the determining unit 114 (step S85). The acquisition unit 111 obtains the GPU utilization ratio, periodically.

The acquisition unit 111 sleeps for a predetermined time (step S87). Then, the acquisition unit 111 determines whether or not the operation stop request is received from the activation monitor 110 (step S89). When the operation stop request has not been received (step S89: No route), the processing returns to the step S83. On the other hand, when the operation stop request is received (step S89: Yes route), the processing ends.

By performing the aforementioned processing, it is possible to detect the change of the utilization state of the GPU.

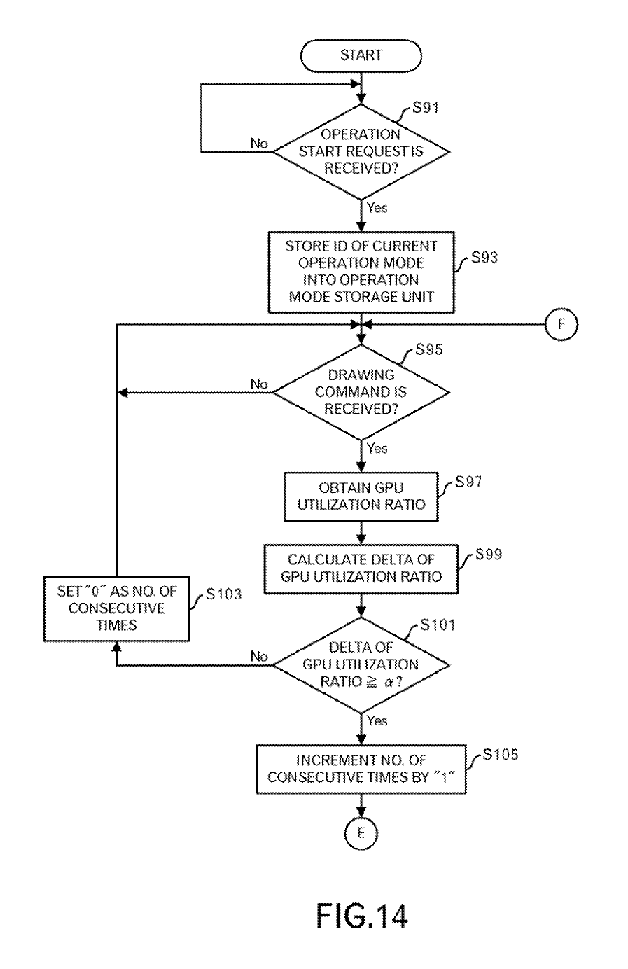

Next, a processing of the determining unit 114 will be explained by using FIGS. 14 to 18. First, the determining unit 114 determines whether or not an operation start request is received from the activation monitor 110 (FIG. 14: step S91). When the operation start request has not been received (step S91: No route), the processing returns to the step S91.

On the other hand, when the operation start request is received (step S91: Yes route), the determining unit 114 stores an identifier of the current operation mode into the operation mode storage unit 117 (step S93). Incidentally, an identifier of the operation mode has already been stored in the column of the operation mode before the GPU application 10 is activated.

The determining unit 114 determines whether or not a drawing command is received from the API monitor 112 (step S95). When the drawing command has not been received (step S95: No route), the processing returns to the step S95. On the other hand, when the drawing command is received (step S95: Yes route), the determining unit 114 stores the drawing command into the storage unit. Moreover, the determining unit 114 obtains the GPU utilization ratio from the acquisition unit 111, and stores the obtained GPU utilization ration into the storage unit (step S97). Incidentally, the determining unit 114 stores at least n drawing commands into the storage unit.

The determining unit 114 calculates a delta of the GPU utilization ratios by calculating a difference between the GPU utilization ratio that was obtained previous time and the GPU utilization ratio that was obtained this time (step S99). Then, the determining unit 114 determines whether or not the delta of the GPU utilization ratios is equal to or greater than a threshold α (step S101). The threshold α is predetermined by the administrator of the server 1 or the like. When the delta is not equal to or greater than the threshold α (step S101: No route), the operation mode is not changed, and the determining unit 114 sets “0” as a variable value representing the number of consecutive times (step S103), and the processing returns to the step S95.

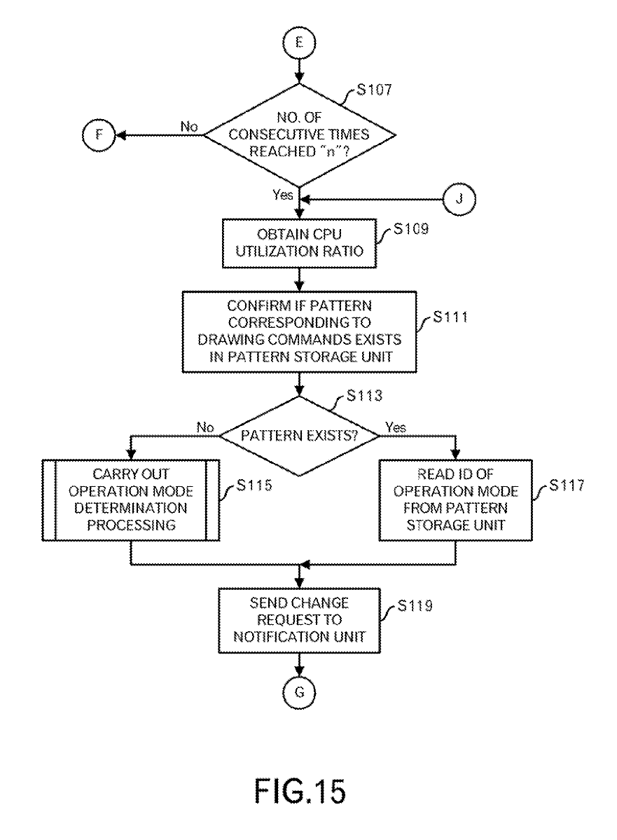

On the other hand, when the delta of the GPU utilization ratio is equal to or greater than the threshold α (step S101: Yes route), the determining unit 114 increments the variable value representing the number of consecutive times by “1” (step S105). The processing shifts to step S107 in FIG. 15 through a terminal E.

Shifting to the explanation of FIG. 15, the determining unit 114 determines whether or not the variable value representing the number of consecutive times is n (n is a natural number equal to or greater than “2”) (step S107). When the variable value representing the number of consecutive times does not reach n (step S107: No route), the processing shifts to step S95 in FIG. 14 through a terminal F.

On the other hand, when it is determined that the variable value representing the number of consecutive times reached the threshold n (step S107: Yes route), the determining unit 114 obtains the CPU utilization ratio, and stores the obtained CPU utilization ratio into the storage unit (step S109). Moreover, the determining unit 114 determines whether or not a pattern corresponding to a combination of drawing commands, GPU utilization ratio and CPU utilization ratio is registered in the pattern storage unit 113 (step S111).

When a pattern corresponding to the combination of the drawing commands, GPU utilization ratio and CPU utilization ratio exists (step S113: Yes route), the determining unit 114 reads out an identifier stored in a column of the operation mode to be applied for that pattern from the pattern storage unit 113 (step S117). On the other hand, when there is no pattern corresponding to the combination of the drawing commands, GPU utilization ratio and CPU utilization ratio (step S113: No route), the determining unit 114 performs the operation mode determination processing (step S115). The operation mode determination processing is the same as the processing explained by using FIG. 9.

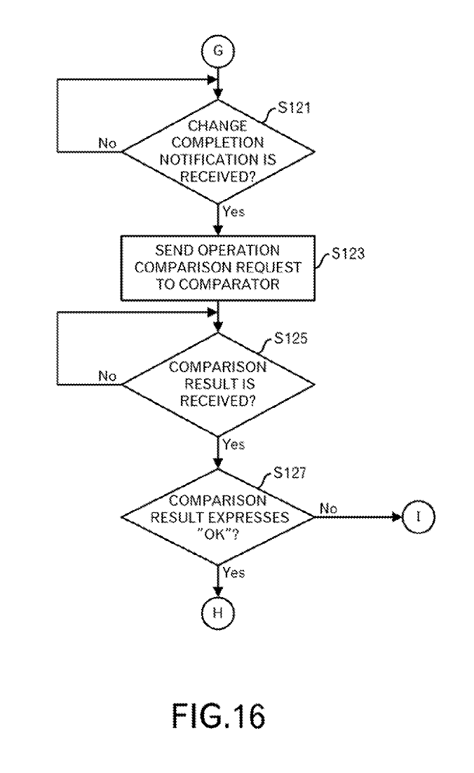

When an identifier of the operation mode is identified at the step S115, or an identifier of the operation mode is reads out at the step S117, the determining unit 114 transmits a change request including the identifier of the operation mode to the notification unit 116. Then, the processing shifts to step S121 in FIG. 16 through a terminal G.

Shifting to the explanation of FIG. 16, the determining unit 114 determines whether or not a change completion notification is received from the notification unit 116 (step S121). When the change completion notification has not been received (step S121: No route), the processing returns to the step S121.

On the other hand, when the change completion notification is received (step S121: Yes route), the determining unit 114 transmits an operation comparison request to the comparator 115 (step S123).

The determining unit 114 determines whether or not a comparison result is received from the comparator 115 (step S125). When no comparison result has been received (step S125: No route), the processing returns to the step S125.

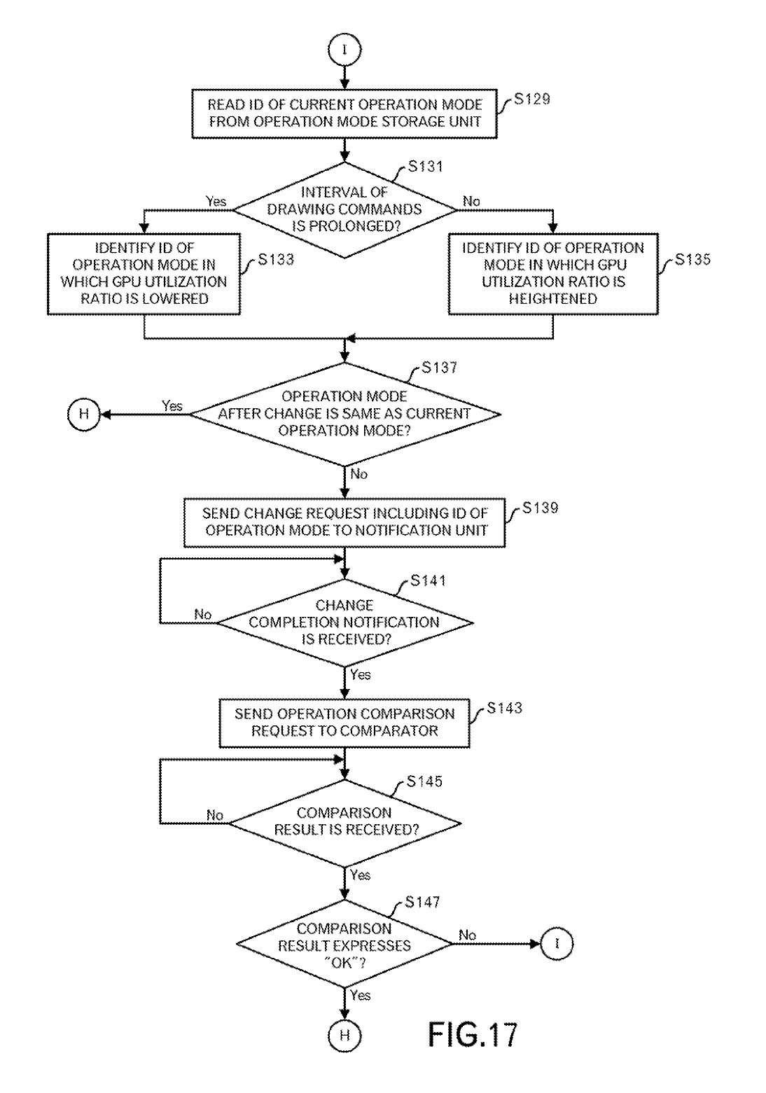

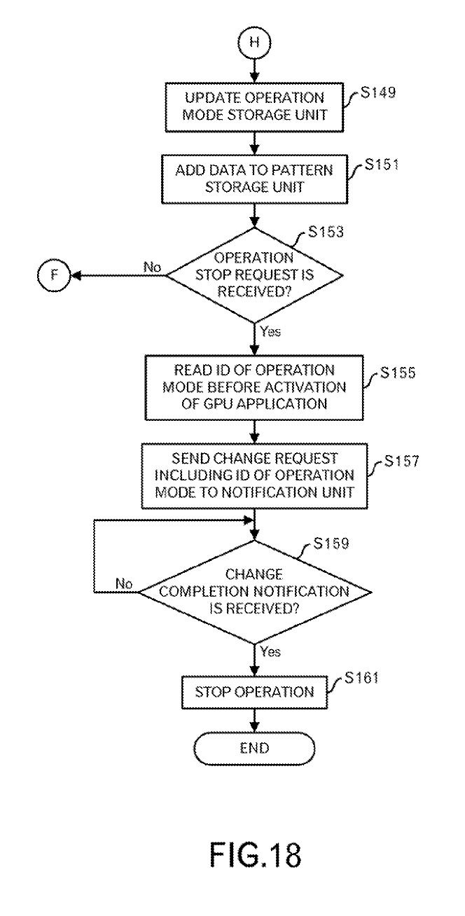

On the other hand, when the comparison result is received (step S125: Yes route), the determining unit 114 determines whether or not the comparison result represent “OK” (step S127). When the interval of the drawing commands is shortened and the frame rate increases by the change of the operation mode, the comparison result represents “OK”. When the comparison result represents “OK” (step S127: Yes route), the processing shifts to step S149 in FIG. 18 through a terminal H. When the comparison result represents “NG” instead of “OK” (step S127: No route), the processing shifts to step S129 in FIG. 17 through a terminal I.

Shifting to the explanation of FIG. 17, the determining unit 114 reads out an identifier of the current operation mode from the operation mode storage unit 117 (step S129). Then, the determining unit 114 determines whether or not the comparison result notified from the comparator 115 represents that the interval of the drawing commands becomes long (step S131). When the comparison result represents that the interval of the drawing commands becomes long (step S131: Yes route), the determining unit 114 identifies an identifier of the operation mode in which the GPU utilization ratio is lowered than the current operation mode (step S133). This is because the processing of the GPU application 10 may be delayed due to the change of the operation mode. For example, when the identifier of the current operation mode is “level-3”, “level-0”, “level-1” or “level-2” is identified as the identifier of the operation mode.

On the other hand, when the interval of the drawing commands becomes short (step S131: No route), this represents that the processing speed of the GPU application 10 is heightened, however, the frame rate is lowered. Therefore, the determining unit 114 identifies an identifier of the operation mode in which the GPU utilization ratio is heightened than the current operation mode (step S135). Because the GPU 16 has a surplus capability, the load of the CPU 17 is reduced by allocating parts of the processing of the screen controller 12 to the GPU 16. For example, when the identifier of the current operation mode is “level-3”, “level-4” or “level-5” is identified as the identifier of the operation mode.

The determining unit 114 determines whether or not the operation mode after the change is the same as the current operation mode (step S137). When it is determined that the operation mode after the change is the same as the current operation mode (step S137: Yes route), the processing shifts to step S149 of FIG. 18 through the terminal H.

On the other hand, when the operation mode after the change is not the same as the current operation mode (step S137: No route), the determining unit 114 transmits a change request including the identifier of the operation mode, which was identified at the step S133 or S135, to the notification unit 116 (step S139).

The determining unit 114 determines whether or not a change completion notification is received from the notification unit 116 (step S141). When the change completion notification has not been received (step S141: No route), the processing returns to the processing of the step S141.

When the change completion notification is received (step S141: Yes route), the determining unit 114 transmits an operation comparison request to the comparator 115 (step S143).

The determining unit 114 determines whether or not the comparison result is received from the comparator 115 (step S145). When the comparison result has not been received (step S145: No route), the processing returns to the step S145. On the other hand, when the comparison result is received from the comparator 115 (step S145: Yes route), the determining unit 114 determines whether or not the comparison result represents “OK” (step S147). When the comparison result represents “NG” instead of “OK” (step S147: No route), the processing returns to the step S129 through the terminal I. When the comparison result represents “OK” (step S147: Yes route), the processing shifts to step S149 of FIG. 18 through the terminal H.

Shifting to the explanation of FIG. 18, the determining unit 114 updates data stored in the operation mode storage unit 117 (step S149). Specifically, the column of the operation mode before the change is updated with the identifier of the operation mode stored in the column of the current operation mode in the operation mode storage unit 117. Moreover, the column of the current operation mode is updated with the identifier of the operation mode, which was identified at the step S133 or S135.

The determining unit 114 adds data of a pattern to the pattern storage unit 113 (step S151). Specifically, first, a new pattern number is assigned. Moreover, the identifier of the current operation mode is stored in the column of the operation mode to be applied, and the identifier of the operation mode before the change is stored in the column of the operation mode before the change. Furthermore, the obtained data is stored in each column of the combination of the drawing commands, GPU utilization ratio and CPU utilization ratio. However, when a similar pattern has already been stored in the pattern storage unit 113 (e.g. when the processing of the step S117 is carried out), the processing of the step S151 may not be performed.

The determining unit 114 determines whether or not the operation stop request is received from the activation monitor 110 (step S153). When the operation stop request has not been received (step S153: No route), the processing returns to the step S95 in FIG. 14 through the terminal F.

On the other hand, when the operation stop request is received (step S153: Yes route), the determining unit 114 reads out the identifier of the operation mode before the activation of the GPU application 10 from the operation mode storage unit 117 (step S155). Moreover, the determining unit 114 transmits a change request including the identifier of the operation mode, which was read at the step S155 to the notification unit 116 (step S157).

Then, the determining unit 114 determines whether or not the change completion notification is received from the notification unit 116 (step S159). When the change completion notification has not been received (step S159: No route), the processing returns to the step S159. On the other hand, when the change completion notification is received (step S159: Yes route), the determining unit 114 stops its operation (step S161), and the processing ends.

By performing the aforementioned processing, it is possible to identify the operation mode according to the GPU utilization ratio not so as to badly influence the image processing by the GPU application 10.

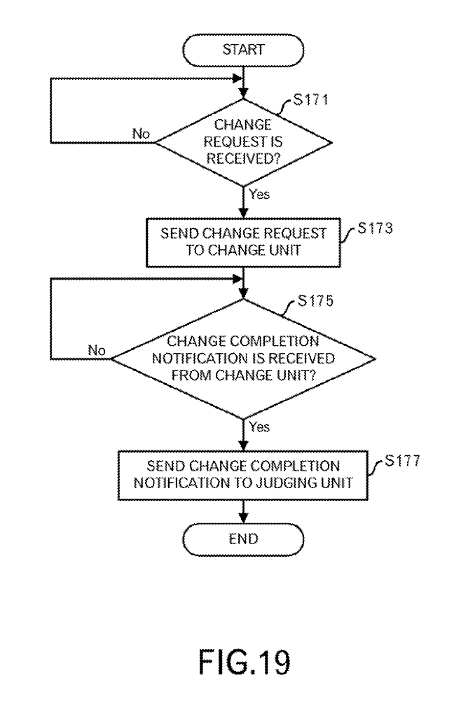

Next, the processing of the notification unit 116 will be explained by using FIG. 19. First, the notification unit 116 determines whether or not a change request is received from the determining unit 114 (FIG. 19: step S171). When the change request has not been received (step S171: No route), the processing returns to the processing of the step S171.

On the other hand, when the change request is received (step S171: Yes route), the notification unit 116 transmits the change request to the change unit 127 (step S173).

The notification unit 116 determines whether or not a change completion notification is received from the change unit 127 (step S175). When the change completion notification has not been received (step S175: No route), the processing returns to the step S175.

On the other hand, when the change completion notification is received (step S175: Yes route), the notification unit 116 transmits the change completion notification to the determining unit 114 (step S177). Then, the processing ends.

By performing the aforementioned processing, it is possible to appropriately exchange the information between the screen controller 12 and the manager 11.

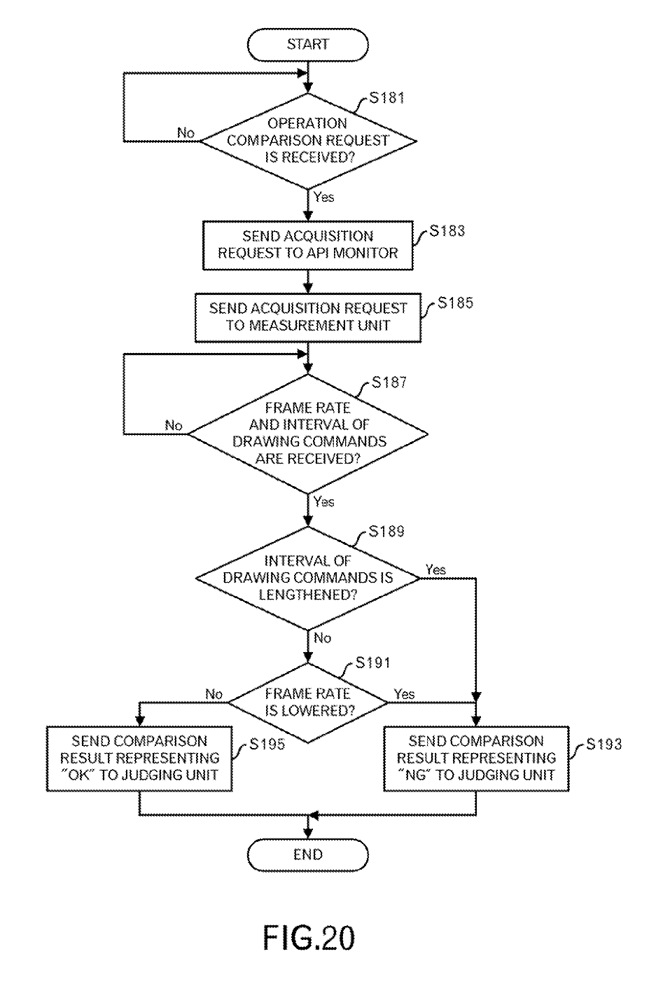

Next, a processing of the comparator 115 will be explained by using FIG. 20. First, the comparator 115 determines whether or not an operation comparison request is received from the determining unit 114 (FIG. 20: step S181). When the operation comparison request has not been received (step S181: No route), the processing returns to the step S181.

On the other hand, when it is determined that the operation comparison request is received (step S181: Yes route), the comparator 115 transmits an acquisition request for requesting the intervals of the drawing commands before and after the change of the operation mode to the API monitor 112 (step S183). Moreover, the comparator 115 transmits an acquisition request for requesting the frame rates before and after the change of the operation mode to the measurement unit 125 (step S185).

The comparator 115 determines whether or not the intervals of the drawing commands and the frame rates are received (step S187). When the frame rates and the intervals of the drawing commands have not been received (step S187: No route), the processing returns to the step S187.

On the other hand, when the frame rates and the intervals of the drawing commands are received (step S187: Yes route), the comparator 115 determines whether or not the interval of the drawing commands becomes long after the change of the operation mode (step S189). When the interval of the drawing commands becomes long after the change of the operation mode (step S189: Yes route), the comparator 115 transmits the comparison result representing “NG” to the determining unit 114 (step S193). This is because the processing of the GPU application 10 may be delayed due to the change of the operation mode. On the other hand, when the interval of the drawing commands becomes short (step S189: No route), the comparator 115 determines whether or not the frame rate is lowered (step S191).

When it is determined that the frame rate is lowered (step S191: Yes route), the comparator 115 transmits the comparison result representing “NG” to the determining unit 114 (step S193). This is because, when the frame rate is lowered, the screen may not be appropriately displayed in the client terminal 5. On the other hand, when it is determined that the frame rate is heightened (step S191: No route), the comparator 115 transmits the comparison result representing “OK” to the determining unit 114 (step S195). Then, the processing ends.

By performing the aforementioned processing, it is possible to confirm whether or not the delay in the image processing by GPU application 10 occurs or the frame rate is lowered after the change of the operation mode.

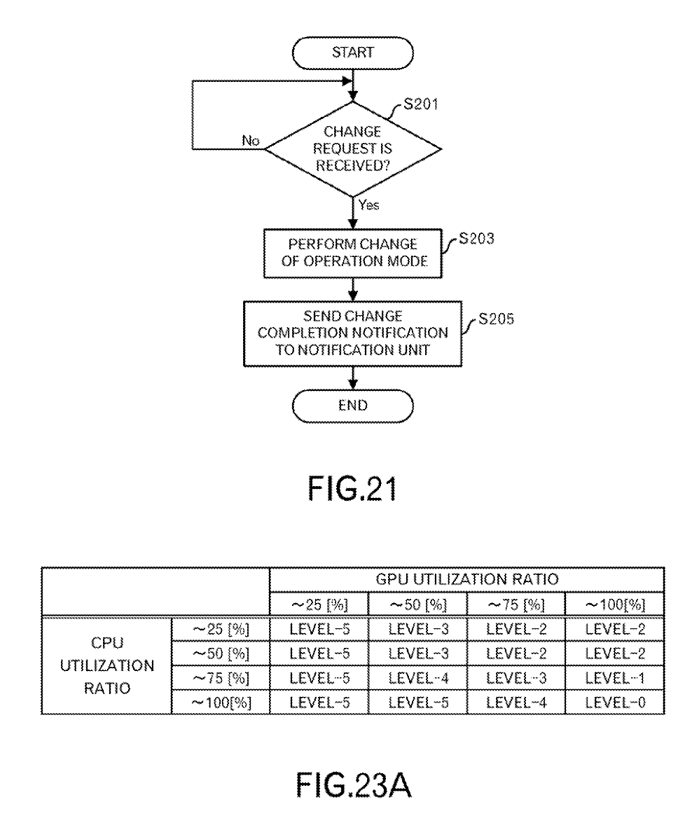

Next, the processing of the change unit 127 will be explained by using FIG. 21. First, the change unit 127 determines whether or not a change request is received from the notification unit 116 (FIG. 21: step S201). When the change request has not been received (step S201: No route), the processing returns to the step S201. On the other hand, when the change request is received (step S201: Yes route), the change unit 127 performs the change of the operation mode (step S203). Moreover, the change unit 127 transmits a change notification representing the operation mode is changed to the measurement unit 125.

For example, when “level-3” of the operation mode is changed to “level-5”, a setting is made newly for the first transmitter 121 and second transmitter 126 so that the GPU 16 performs the processing. Reversely, when “level-5” of the operation mode is changed to “level-3”, a setting is made for the first transmitter 121 and second transmitter 126 so that the CPU 17 performs the processing.

Then, the change unit 127 transmits a change completion notification to the notification unit 116 (step S205). Then, the processing ends.

By performing the aforementioned processing, it becomes possible to switch the execution of the GPU 16 and the execution of the CPU 17 according to the operation mode determined by the manager 11.

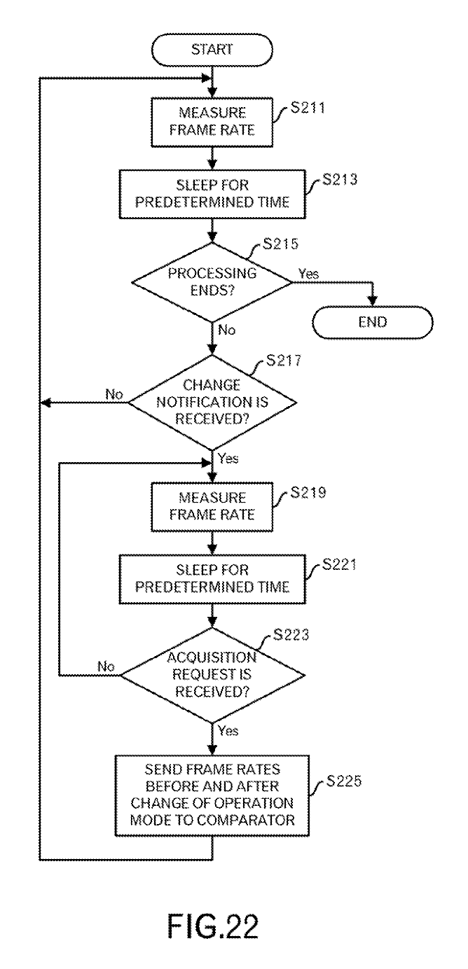

Next, FIG. 22 represents a processing of the measurement unit 125. Firstly, the measurement unit 125 measures the frame rate for the processing to transmit the screen data to the client terminal 5, and stores the measured frame rate into the storage unit (FIG. 22: step S211). Then, the measurement unit 125 sleeps for a predetermined time (step S213). After that, the measurement unit 125 determines whether or not the processing would end (step S215). For example, when the connection between the server 1 and the client terminal 5 is disconnected, the processing ends (step S215: Yes route). On the other hand, when the processing does not end (step S215: No route), the measurement unit 125 determines whether or not a change notification representing the change of the operation mode is received from the change unit 127 (step S127).

When the change notification has not been received (step S217: No route), the processing returns to the step S211. On the other hand, when the change notification is received (step S217: Yes route), the measurement unit 125 measures the frame rate for the processing to transmit the screen data to the client terminal 5, and stores the measured frame rate into the storage unit (step S219). Then, the measurement unit 125 sleeps for the predetermined time (step S221).

Then, the measurement unit 125 determines whether or not an acquisition request is received from the comparator 115 (step S223). When the acquisition request has not been received (step S223: No route), the processing returns to the step S219. On the other hand, when the acquisition request is received (step S223: Yes route), the measurement unit 125 transmits the frame rates before and after the change of the operation mode to the comparator 115 (step S225). Then, the processing returns to the step S211.

By performing the aforementioned processing, it is possible to compare the frame rates before and after the change of the operation mode.

### Embodiment 2

In the operation mode determination processing (FIG. 9) in the first embodiment, the operation mode is determined by using the GPU utilization ratio. In the embodiment 2, the operation mode is determined based on the GPU utilization ratio and CPU utilization ratio.

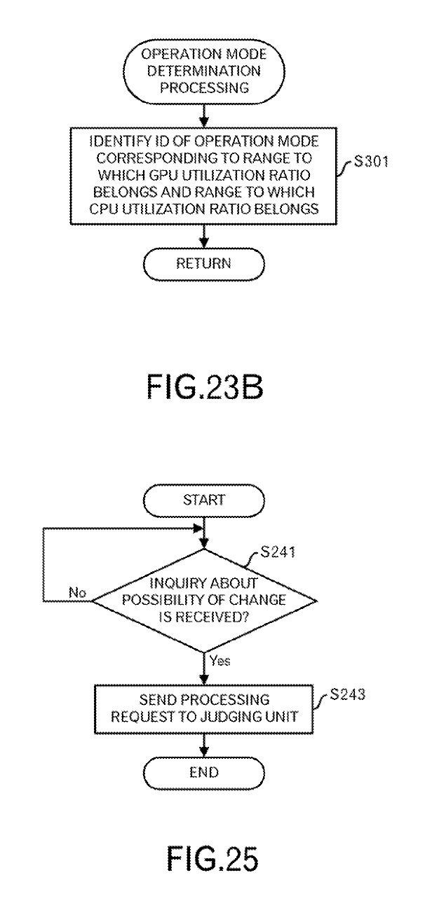

FIG. 23A illustrates an example of data stored in the determined data storage unit 118 in the second embodiment. In an example of FIG. 23A, an identifier of the operation mode is stored in association with a combination of a range of the GPU utilization ratio and a range of the CPU utilization ratio. By using such data, a processing as illustrated in FIG. 23B is performed.

The determining unit 114 identifies an identifier of the operation mode corresponding to the range to which the GPU utilization ratio obtained at the step S7 belongs and the range to which the CPU utilization ratio obtained at the step S19 belongs from the determined data storage unit 118 (FIG. 23B: S301). Then, the processing ends.

By performing such a processing, it becomes possible to determine the operation mode by taking into account not only the GPU utilization ratio but also the CPU utilization ratio.

### Embodiment 3

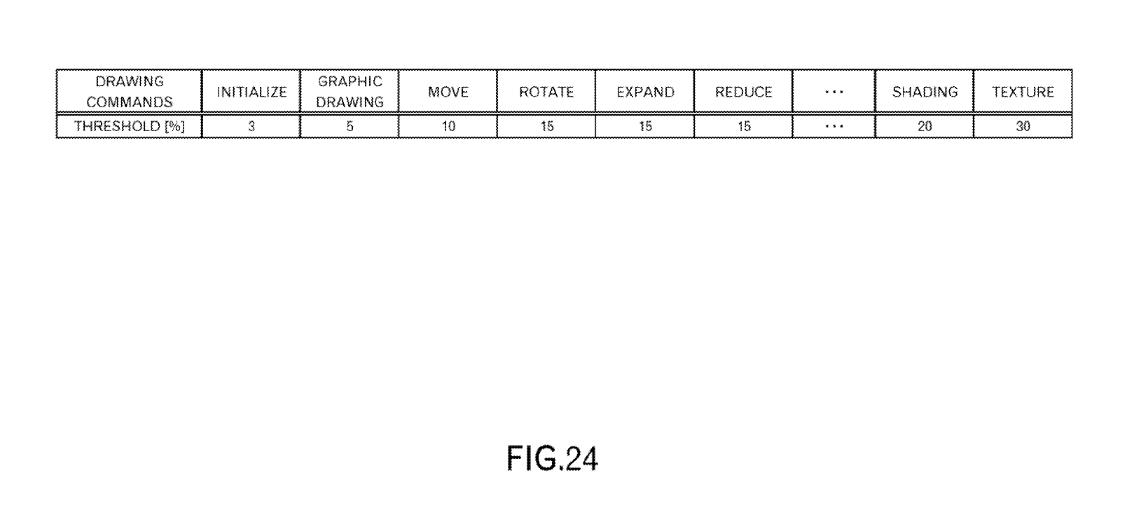

In the embodiment 3, a different value for the threshold for the delta of the GPU utilization ratio is used for each drawing command. FIG. 24 illustrates a setting example of the threshold for each drawing command. The kinds of drawing commands are not limited to those illustrated in FIG. 24.

In the embodiment 3, at the step S97, the determining unit 114 obtains the GPU utilization ratio for each drawing command. As a premise, the acquisition unit 111 obtains the GPU utilization ratio for each drawing command through the GPU driver 14, and transmits the obtained GPU utilization ratios to the determining unit 114. Moreover, at the step S101, the determining unit 114 determines whether or not the delta of the GPU utilization ratios exceeds the threshold for each drawing command. At that time, when the delta of the GPU utilization ratios for any one of the drawing commands exceeds the threshold, the processing may advance to the step S105, and when the delta whose threshold is maximum exceeds that threshold, the processing may advance to the step S105.

Thus, it becomes possible to appropriately detect the timing when the operation mode should be changed.

### Embodiment 4

In the embodiment 4, the drawing commands to be monitored by the API monitor 112 are limited. For example, at the step S97, the determining unit 114 obtains the GPU utilization ratios only for specific drawing commands. As a premise, the acquisition unit 111 obtains the GPU utilization ratios only for the specific drawing commands through the GPU driver 14, and transmits the obtained GPU utilization ratios to the determining unit 114. Moreover, at the step S101, the determining unit 114 compares the delta of the GPU utilization ratio with the preset threshold for the specific drawing commands, and the processing advances to the step S105 when the delta of the GPU utilization ratio exceeds the threshold.

By doing so, it is possible to reduce the processing loads of the API monitor 112 and determining unit 114.

### Embodiment 5

In the embodiment 5, when a predetermined cause by which the operation mode should be changed in the screen controller 12 occurs, the change of the operation mode is performed. The predetermined reason may be an event where the transmission of the movie starts or stops in the second transmitter 126, for example, and an event where the delta of the frame rate exceeds a predetermined threshold.

A processing of the notification unit 116 in the embodiment 5 will be explained by using FIG. 25. Firstly, the notification unit 116 determines whether or not an inquiry of whether or not the operation mode can be changed is received from the change unit 127 (FIG. 25: step S241). When the inquiry of whether or not the change can be made has not been received (step S241: No route), the processing returns to the step S241. On the other hand, when the inquiry of whether or not the change can be made is received (step S241: Yes route), the notification unit 116 transmits a processing request for requesting the change of the operation mode to the determining unit 114 (step S243). Then, the processing ends.

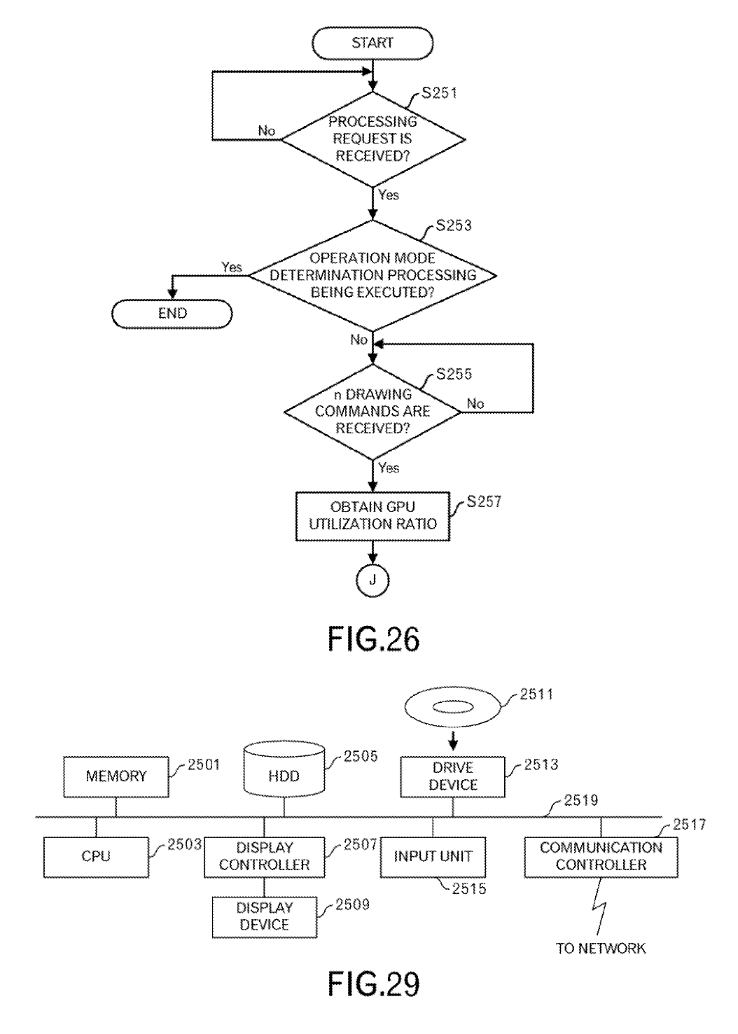

A processing of the determining unit 114 in the embodiment 5 will be explained by using FIG. 26. This processing is executed by a thread different from the aforementioned processing of the determining unit 114.

Firstly, the determining unit 114 determines whether or not a processing request is received from the notification unit 116 (FIG. 26: step S251). When the processing request has not been received (step S251: No route), the processing returns to the step S251. On the other hand, when the processing request is received (step S251: Yes route), the determining unit 114 determines whether or not the operation mode determination processing is being executed (step S253). When the operation mode determination processing is being executed (step S253: Yes route), there is no need to newly execute the operation mode determination processing. Therefore, the processing ends. On the other hand, when the operation mode determination processing is not being executed (step S253: No route), the determining unit 114 determines whether or not n drawing commands are received (step S255).

When n drawing commands are not received (step S255: No route), the processing returns to the step S255. On the other hand, when the n drawing commands are received (step S255: Yes route), the determining unit 114 obtains the GPU utilization ratio from the acquisition unit 111 (step S257). Then, the processing shifts to the step S109 of FIG. 15 through a terminal J.

By performing the aforementioned processing, it becomes possible to change the operation mode not only when the GPU application 10 is activated, but also when a predetermined cause by which the operation mode should be changed in the screen controller 12 occurs.

### Embodiment 6

In this embodiment, a processing will be explained in which the change to the operation mode (in this embodiment, the operation modes of level-3 to level-5) consuming a large amount of the GPU memory is prevented when the acquisition of the GPU memory is failed in the processing of the screen controller 12.

In this embodiment, the acquisition unit 111 obtains not only the GPU utilization ratio but also the utilized amount of the GPU memory at the step S83, and transmits the obtained data to the determining unit 114 at the step S85. In addition, the notification unit 116 can perform the same processing as that in the embodiment 5.

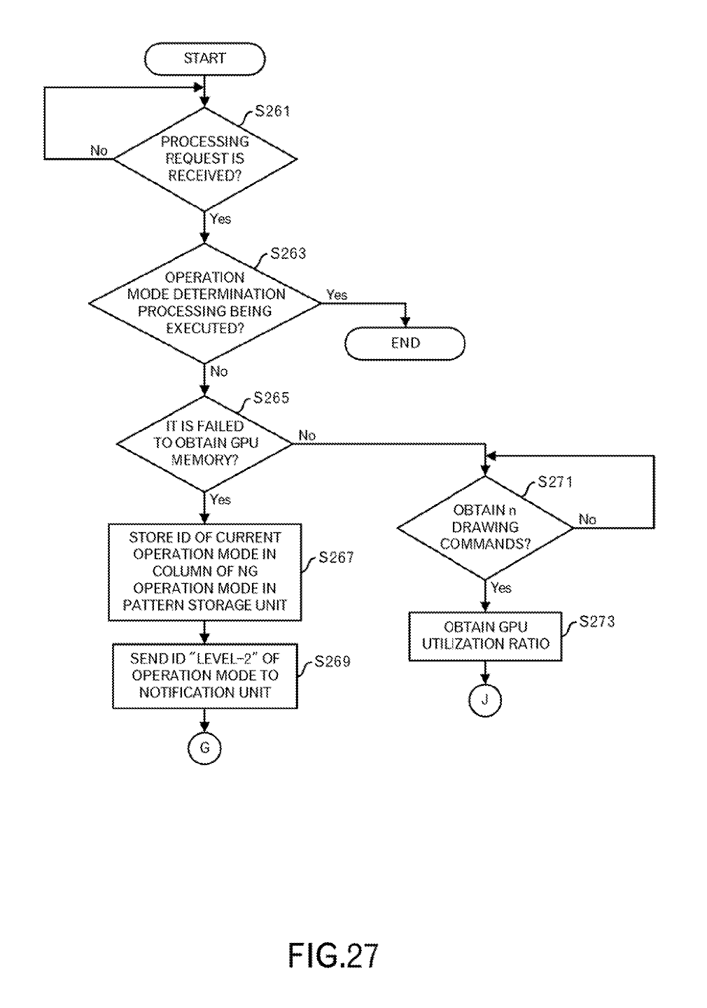

Then, the determining unit 114 in this embodiment performs a processing as illustrated in FIG. 27 by a thread different from a thread for the aforementioned processing. As a premise, when a record was stored in the pattern storage unit 113 at previous time, the determining unit 114 stores the pattern number of that record in the storage device.

Firstly, the determining unit 114 determines whether or not a processing request is received from the notification unit 116 (FIG. 27: step S261). When the processing request has not been received (step S261: No route), the processing returns to the step S261. On the other hand, when the processing request is received (step S261: Yes route), the determining unit 114 determines whether or not the operation mode determination processing is being performed (step S263).

When the operation mode determination processing is being performed (step S263: Yes route), there is no need to newly perform the operation mode determination processing, and the processing ends. On the other hand, when the operation mode determination processing is not being performed (step S263: No route), the determining unit 114 determines whether or not information representing the acquisition of the GPU memory was failed is included in the processing request (step S265).

When the processing request does not include the information representing the acquisition of the GPU memory was failed (step S265: No route), the determining unit 114 determines whether or not n drawing commands are received (step S271).

When the n drawing commands have not been received (step S271: No route), the processing returns to the step S271. On the other hand, when the n drawing commands are received (step S271: Yes route), the determining unit 114 obtains the GPU utilization ratio from the acquisition unit 111 (step S273). Then, the processing shifts to the step S109 of FIG. 15 through the terminal J.

On the other hand, when the processing request includes the information representing the acquisition of the GPU memory was failed (step S265: Yes route), the determining unit 114 stores an identifier of the current operation mode in the column of the NG operation mode corresponding to the pattern number stored in the storage unit in the pattern storage unit 113 (step S267). In addition, the identifier of the operation mode stored in the column of the operation mode to be applied is changed to “level-2”, and the utilized amount of the GPU memory obtained at the step S83 is stored in the column of the utilized amount of the GPU memory.

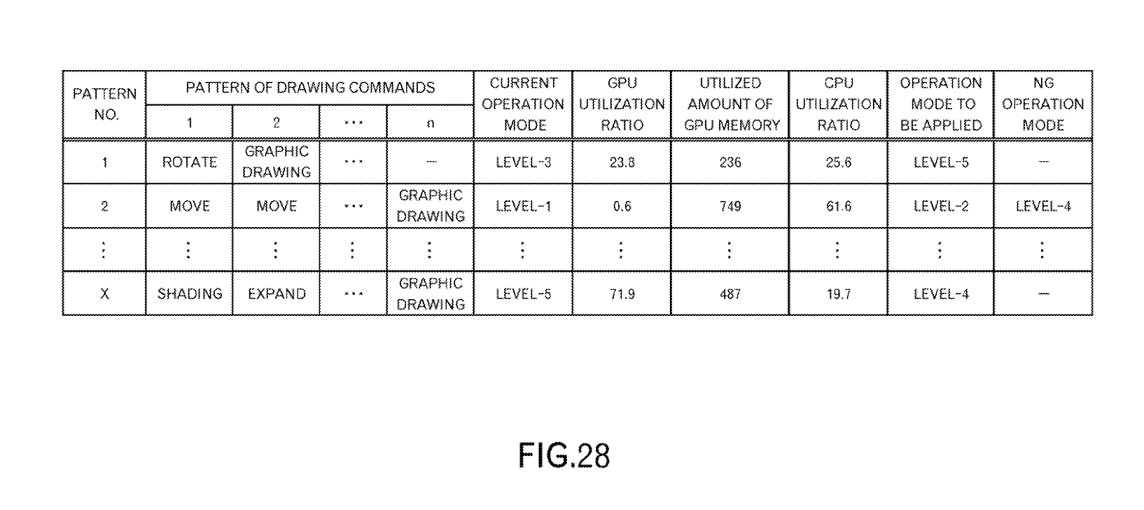

FIG. 28 illustrates an example of data stored in the pattern storage unit 113 in the embodiment 6. In an example of FIG. 28, the pattern number, combination of the drawing commands, identifier of the current operation mode, GPU utilization ratio, utilized amount of GPU memory, CPU utilization ratio, identifier of the operation mode to be applied and identifier of NG operation mode (operation mode not to be applied) are stored.

Then, the determining unit 114 transmits a change request including the identifier “level-2” of the operation mode to the notification unit 116 (step S269). Then, the processing shifts to the step S121 of FIG. 16 through the terminal G.

By performing such a processing, it is possible not to change the operation mode to the operation mode consuming the large amount of GPU memory when the acquisition of the GPU memory was failed in the processing of the screen controller 12.

Although the embodiments of this technique were explained above, this technique is not limited to the aforementioned embodiments. For example, the aforementioned functional block diagram of the server 1 may not correspond to a program module configuration.

Moreover, the structure of each table described above is a mere example, and the aforementioned structure may be changed. Furthermore, as long as the processing results do not change, the order of the steps may be changed or plural steps may be executed in parallel.

Moreover, in the embodiment 6, the operation modes consuming the large amount of GPU memory were “level-3” to “level-5”. However, such operation modes are not limited to them. In addition, the operation mode may not be changed to “level-2”, and the operation mode may be changed to “level-0” or “level-1”.

In addition, the aforementioned server 1 and client terminal 5 are computer devices as illustrated in FIG. 29. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as illustrated in FIG. 29. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the application programs systematically cooperate with each other, so that various functions as described above in details are realized.

The embodiments described above are summarized as follows:

An information processing method relating to the embodiments is executed by a first processor (e.g. CPU) included in a computer further including a second processor (e.g. GPU). Then, the information processing method includes: (A) while the second processor executes an image processing, obtaining utilization ratios of the second processor at two or more timings; (B) first determining, by using the obtained utilization ratios, whether or not a predetermined change occurred in the utilization ratios of the second processor; (C) upon determining that the predetermined change occurred, second determining, based on obtained utilization ratios, which processes of a plurality of processes to be executed to display screen data on a client terminal should be allocated to the second processor; and (D) carrying out a setting to execute the plurality of processes according to a determination result.

By carrying out the aforementioned processing, it is possible to suppress the influence to the image processing by the second processor, and effectively utilize the second processor. In addition, it is possible to improve the response to an operation in the client terminal.

Moreover, the aforementioned information processing methods may further include: (E) obtaining a plurality of commands for the image processing, which are outputted to the second processor; (F) calculating a first interval of the plurality of commands before the carrying out, by using obtaining time data of the obtained plurality of commands before the carrying out; (G) calculating a second interval of the plurality of commands after the carrying out, by using obtaining time data of the obtained plurality of commands after the carrying out; (H) comparing the first interval with the second interval; and (I) upon detecting that the second interval is longer than the first interval, carrying out a setting so that the first processor executes any one process of processes that are determined in the second determining to be allocated to the second processor. When the interval of the commands becomes long, the speed of the image processing may be delayed. Then, when there may be an influence to the image processing by the second processor, it becomes possible to suppress the influence by further changing the setting.

Furthermore, the aforementioned information processing method may further include: (J) measuring a frame rate for a processing to transmit the screen data to the client terminal; (K) comparing a first frame rate before the carrying out with a second frame rate after the carrying out; and (L) upon detecting that the second interval is shorter than the first interval and the second frame rate is lower than the first frame rate, carrying out a setting so that the second processor executes any one process of processes that are determined in the second determining not to be allocated to second processor. When the frame rate is lowered, the screen data may not be appropriately displayed (e.g. frame-by-frame playback may occur). Then, when the second processor has a surplus capability because the interval of the commands is shortened, it becomes possible that the processes to be allocated to the second processor are increased to reduce the loads of the first processor.

In addition, the aforementioned information processing method may further include: (M) obtaining a utilization ratio of the first processor; and (N) upon detecting that the second interval is shorter than the first interval and the second frame rate is higher than the first frame rate, storing a data block including a utilization ratio of the second processor, which was obtained before the carrying out, the utilization ratio of the first processor and a combination of commands in association with an identifier of a set of processes that are determined in the second determining to be allocated to the second processor, into a first data storage unit. By leaving the data block when the appropriate setting can be made, it is possible to simply carry out the setting by using the data block later.

Moreover, the aforementioned second determining may include: (c1) identifying an increased value corresponding to an identifier of a set of processes to which the second processor is allocated at the second determining, from a second data storage unit storing a plurality of combinations, each of which includes an identifier of a set of processes to which the second processor is allocated and an increased value of the utilization ratio of the second processor when the second processor executes the set of processes; (c2) calculating a difference between the identified increased value and an increased value corresponding to an identifier of each set of the other sets stored in the second data storage unit; (c3) calculating, for each set of the other sets, a utilization ratio of the second processor in case where processes included in the set are allocated to the second processor, by adding the calculated difference for the set and the obtained utilization ratio of the second processor; and (c4) identifying an identifier of a set whose calculated utilization ratio of the second processor is nearest to a target value from among identifiers of the other sets. By carrying out such a processing, it becomes possible to carry out a setting so that the utilization ratio of the second processor gets nearest to a predetermined target value.

In addition, the aforementioned second determining comprises: (c5) identifying an identifier of a set of processes, which corresponds to a combination of a range to which the obtained utilization ratio of the second processor belongs and a range to which the obtained utilization ratio of the first processor belongs, from a third data storage unit storing a range of a utilization ratio of the second processor and a range of a utilization ratio of the first processor in association with an identifier of a set of processes allocated to the second processor. By carrying out such a processing, it is possible to identify a set of processes to be allocated to the second processor taking into consideration not only the utilization ratio of the second processor but also the utilization ratio of the first processor.

Furthermore, the aforementioned second determining may include: (c6) identifying an identifier of a set of processes, which corresponds to a data block nearest to the obtained utilization ratio of the second processor, the obtained utilization ratio of the first processor and the combination of commands from the first data storage unit. By carrying out such a processing, it becomes possible to simply carry out a setting by using the data block having the used result.

Moreover, first determining may include: (b1) determining whether or not a delta of the utilization ratios of the second processor is consecutively equal to or greater than a predetermined reference, a predetermined number of times. For example, when the image processing is carried out in response to an instruction from the user, the delta of the utilization ratios of the second processor may temporarily increase. Then, by carrying out such a processing, it becomes possible to appropriately detect a timing the second determining is to be executed.

Moreover, the aforementioned obtaining may include: (a1) obtaining, for each of processes included in the image processing, utilization ratios of the second processor at two or more timings. Then, the aforementioned first determining may include: (b2) determining whether or not a delta of the utilization ratios of the second processor for any one process of the processes included in the image processing consecutively exceeds a predetermined reference a predetermined number of times. The commands for the image processing include a command to draw a line, a command for coloring, a command for moving an object, a command for rotating the object, and the like, and sizes of the utilization ratios vary depending on the respective commands. Then, by carrying out the aforementioned processing, it is possible to appropriately detect the timing the second determining should be carried out.

In addition, the aforementioned obtaining may include: (a2) obtaining utilization ratios of the second processor at two or more timings for a first process included in the processed included in the image processing. Then, the aforementioned first determining may include: (b3) determining whether or not a delta of the utilization ratios of the second processor for the first process consecutively exceeds a predetermined reference set for the first process a predetermined number of times. Because the commands to be processed can be limited, it is possible to reduce the processing load of the obtaining.

Furthermore, the aforementioned information processing method may further include: (O) upon detecting that the second processor fails to acquire a memory to be used in any one of the plurality of processes, adding information representing the set of processes that are determined in the second determining to be allocated to the second processor should not be adopted into the data block stored in the storing; and changing the identifier of the combination in the data block stored in the storing to an identifier of a set of processes whose amount of memory, which is used by the second processor, is less than a predetermined reference. By carrying out such a processing, it is possible to prevent from adopting a set of processes that consume a large amount of memory the second processor uses.

Moreover, the obtaining may be carried out upon detecting that the image processing is executed by the second processor, and a predetermined event occurs in which a processor that is in charge of anyone of the plurality of processes should be changed. By carrying out such a processing, it is possible to execute the obtaining, for example, when it is predicted that the frame rate is lowered because the transmission of movie data is started.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program for causing a first processor included in a computer further including a second processor to execute a procedure, comprising:
while the second processor executes an image processing, obtaining utilization ratios of the second processor at two or more timings;
first determining, by using the obtained utilization ratios, whether or not a predetermined change occurred in the utilization ratios of the second processor;
upon determining that the predetermined change occurred, second determining, based on obtained utilization ratios, which processes of a plurality of processes to be executed to display screen data on a client terminal should be allocated to the second processor; and
performing a setting to execute the plurality of processes according to a determination result.

2. The computer-readable, non-transitory storage medium as set forth in claim 1, wherein the procedure further comprises:
obtaining a plurality of commands for the image processing, which are outputted to the second processor;
calculating a first interval of the plurality of commands before the performing, by using obtaining time data of the obtained plurality of commands before the performing;
calculating a second interval of the plurality of commands after the performing, by using obtaining time data of the obtained plurality of commands after the performing;
comparing the first interval with the second interval; and
upon detecting that the second interval is longer than the first interval, performing a setting so that the first processor executes any one process of processes that are determined in the second determining to be allocated to the second processor.

3. The computer-readable, non-transitory storage medium as set forth in claim 2, wherein the procedure further comprises:
measuring a frame rate for a processing to transmit the screen data to the client terminal;
comparing a first frame rate before the performing with a second frame rate after the performing; and
upon detecting that the second interval is shorter than the first interval and the second frame rate is lower than the first frame rate, performing a setting so that the second processor executes any one process of processes that are determined in the second determining not to be allocated to second processor.

4. The computer-readable, non-transitory storage medium as set forth in claim 3, wherein the procedure further comprises:
obtaining a utilization ratio of the first processor; and
upon detecting that the second interval is shorter than the first interval and the second frame rate is higher than the first frame rate, storing a data block including a utilization ratio of the second processor, which was obtained before the performing, the utilization ratio of the first processor and a combination of commands in association with an identifier of a set of processes that are determined in the second determining to be allocated to the second processor, into a first data storage unit.

5. The computer-readable, non-transitory storage medium as set forth in claim 1, wherein the second determining comprises:
identifying an increased value corresponding to an identifier of a set of processes to which the second processor is allocated at the second determining, from a second data storage unit storing a plurality of combinations, each of which includes an identifier of a set of processes to which the second processor is allocated and an increased value of the utilization ratio of the second processor when the second processor executes the set of processes;
calculating a difference between the identified increased value and an increased value corresponding to an identifier of each set of the other sets stored in the second data storage unit;
calculating, for each set of the other sets, a utilization ratio of the second processor in case where processes included in the set are allocated to the second processor, by adding the calculated difference for the set and the obtained utilization ratio of the second processor; and
identifying an identifier of a set whose calculated utilization ratio of the second processor is nearest to a target value from among identifiers of the other sets.

6. The computer-readable, non-transitory storage medium as set forth in claim 4, wherein the second determining comprises:
identifying an identifier of a set of processes, which corresponds to a combination of a range to which the obtained utilization ratio of the second processor belongs and a range to which the obtained utilization ratio of the first processor belongs, from a third data storage unit storing a range of a utilization ratio of the second processor and a range of a utilization ratio of the first processor in association with an identifier of a set of processes allocated to the second processor.

7. The computer-readable, non-transitory storage medium as set forth in claim 4, wherein the second determining comprises:
identifying an identifier of a set of processes, which corresponds to a data block nearest to the obtained utilization ratio of the second processor, the obtained utilization ratio of the first processor and the combination of commands from the first data storage unit.

8. The computer-readable, non-transitory storage medium as set forth in claim 1, wherein the first determining comprises:
determining whether or not a delta of the utilization ratios of the second processor is consecutively equal to or greater than a predetermined reference, a predetermined number of times.

9. The computer-readable, non-transitory storage medium as set forth in claim 1, wherein the obtaining comprises:
obtaining, for each of processes included in the image processing, utilization ratios of the second processor at two or more timings, and
the first determining comprises:
determining whether or not a delta of the utilization ratios of the second processor for any one process of the processes included in the image processing consecutively exceeds a predetermined reference a predetermined number of times.

10. The computer-readable, non-transitory storage medium as set forth in claim 1, wherein the obtaining comprises:
obtaining utilization ratios of the second processor at two or more timings for a first process included in the processed included in the image processing, and
the first determining comprises:
determining whether or not a delta of the utilization ratios of the second processor for the first process consecutively exceeds a predetermined reference set for the first process a predetermined number of times.

11. The computer-readable, non-transitory storage medium as set forth in claim 4, wherein the procedure further comprises:
upon detecting that the second processor fails to acquire a memory to be used in any one of the plurality of processes, adding information representing the set of processes that are determined in the second determining to be allocated to the second processor should not be adopted into the data block stored in the storing; and
changing the identifier of the combination in the data block stored in the storing to an identifier of a set of processes whose amount of memory, which is used by the second processor, is less than a predetermined reference.

12. The computer-readable, non-transitory storage medium as set forth in claim 1, wherein the obtaining is carried out upon detecting that the image processing is executed by the second processor, and a predetermined event occurs in which a processor that is in charge of any one of the plurality of processes should be changed.

13. An information processing method, comprising:
while the second processor executes an image processing, obtaining, by using a first processor included in a computer further including a second processor, utilization ratios of the second processor at two or more timings;
first determining, by using the first processor, by using the obtained utilization ratios, whether or not a predetermined change occurred in the utilization ratios of the second processor;
upon determining that the predetermined change occurred, second determining, by using the first processor, based on obtained utilization ratios, which processes of a plurality of processes to be executed to display screen data on a client terminal should be allocated to the second processor; and
performing, by using the first processor, a setting to execute the plurality of processes according to a determination result.

14. An information processing apparatus, comprises:
a first processor; and
a second processor, and
wherein the first processor execute a procedure, comprising:
while the second processor executes an image processing, obtaining utilization ratios of the second processor at two or more timings;
first determining, by using the obtained utilization ratios, whether or not a predetermined change occurred in the utilization ratios of the second processor;
upon determining that the predetermined change occurred, second determining, based on obtained utilization ratios, which processes of a plurality of processes to be executed to display screen data on a client terminal should be allocated to the second processor; and
performing a setting to execute the plurality of processes according to a determination result.
